(19) United States
(12) Patent Application Publication
(10) Pub. No.: US 2017/0064352 A1
(43) Pub. Date: Mar. 2, 2017

(54) METHOD AND SYSTEM FOR COLLECTING STATISTICS ON STREAMING MEDIA DATA, AND RELATED APPARATUS

(71) Applicant: TENCENT TECHNOLOGY (SHENZHEN) COMPANY LIMITED, Shenzhen (CN)

(72) Inventors: Xiaomin Xu, Shenzhen (CN); Ning Cao, Shenzhen (CN); Ke Hu, Shenzhen (CN)

(21) Appl. No.: 15/348,440

(22) Filed: Nov. 10, 2016

Related U.S. Application Data
(63) Continuation of application No. PCT/CN2015/078756, filed on May 12, 2015.

(30) Foreign Application Priority Data
May 12, 2014 (CN) 201410198224.8

(51) Int. Cl. H04N 21/24; H04N 21/858; H04N 21/472; H04L 29/06; H04N 21/658; H04N 21/84

(52) U.S. Cl. CPC H04N 21/2407; H04N 21/6581; H04N 21/84; H04N 21/47217; H04L 65/60; H04N 21/8583

(57) ABSTRACT

Embodiments of the present invention disclose a method and system for collecting statistics on streaming media data, and a related apparatus, which are applied to the field of communications technologies. When playing a streaming media program, a client may receive a user flag to mark given streaming media data in the streaming media program, for example, first streaming media data, and send position information of the first streaming media data marked by the user flag, the user flag, and an identifier of the streaming media program to a server, so that the server counts the quantity of user flags on streaming media data at each position of the streaming media program. Each client sends, to the server, user flags on different positions of a streaming media program, and the server counts the quantities of user flags.

### CROSS REFERENCE TO RELATED APPLICATIONS

This is a continuation application of International Patent Application No.: PCT/CN2015/078756, filed on May 12, 2015, which claims priority to Chinese Patent Application No.: 201410198224.8, filed on May 12, 2014, the disclosures of which are incorporated by reference herein in their entirety.

### FIELD OF THE TECHNOLOGY

The present disclosure relates to the field of communications technologies, and in particular, to a method and system for collecting statistics on streaming media data, and a related apparatus.

### BACKGROUND OF THE DISCLOSURE

Currently, in the field of Internet streaming media, for example, in a video network system or an audio network system, a streaming media program for playback is provided for a client by using a streaming media server. However, sometimes the user does not want to play the whole streaming media program on the client, but only wants to view an important or attractive part in the streaming media program, and in this case, the user needs to search for the important or attractive part according to user comments on the streaming media program, or based on thumbnails of the streaming media program, or by playing the whole streaming media program from the beginning to the end on the client.

### SUMMARY

Embodiments of the present invention provide a method and system for collecting statistics on streaming media data, and a related apparatus.

An embodiment of the present invention provides a method for collecting statistics on streaming media data, including:

receiving a user flag when a client plays a streaming media program, the user flag being used for marking first streaming media data in the streaming media program played by the client at a given moment; and

sending an identifier of the streaming media program, position information of the first streaming media data in the streaming media program, and the user flag to a server, so that the server counts the quantity of user flags on streaming media data at at least one position of the streaming media program according to the identifier of the streaming media program, the position information, and user flags.

An embodiment of the present invention further provides a method for collecting statistics on streaming media data, including:

receiving an identifier of a streaming media program, position information of first streaming media data in the streaming media program, and a user flag that are sent by a client, the user flag being used for marking the first streaming media data in the streaming media program played by the client at a given moment; and

counting the quantities of user flags on streaming media data at multiple positions in the streaming media program according to the identifier of the streaming media program, the position information, and user flags.

An embodiment of the present invention further provides a client, including:

a flag receiving unit, configured to receive a user flag when a client plays a streaming media program, the user flag being used for marking first streaming media data in the streaming media program played by the client at a given moment; and

an information sending unit, configured to send an identifier of the streaming media program, position information of the first streaming media data in the streaming media program, and the user flag that is received by the flag receiving unit to a server, so that the server counts the quantity of user flags on streaming media data at at least one position of the streaming media program according to the identifier of the streaming media program, the position information, and user flags.

An embodiment of the present invention further provides a server, including:

an information receiving unit, configured to receive an identifier of a streaming media program, position information of first streaming media data in the streaming media program, and a user flag that are sent by a client, the user flag being used for marking the first streaming media data in the streaming media program played by the client at a given moment; and

a counting unit, configured to count the quantities of user flags on streaming media data at multiple positions in the streaming media program according to the identifier of the streaming media program, the position information, and user flags that are received by the information receiving unit.

An embodiment of the present invention further provides a system for collecting statistics on streaming media data, including a server and multiple clients, where

the client includes:

a flag receiving unit, configured to receive a user flag when a client plays a streaming media program, the user flag being used for marking first streaming media data in the streaming media program played by the client at a given moment; and

an information sending unit, configured to send an identifier of the streaming media program, position information of the first streaming media data in the streaming media program, and the user flag that is received by the flag receiving unit to the server, so that the server counts the quantity of user flags on streaming media data at at least one position of the streaming media program according to the identifier of the streaming media program, the position information, and user flags; and

the server includes:

an information receiving unit, configured to receive an identifier of a streaming media program, position information of first streaming media data in the streaming media program, and a user flag that are sent by a client, the user flag being used for marking the first streaming media data in the streaming media program played by the client at a given moment; and

a counting unit, configured to count the quantities of user flags on streaming media data at multiple positions in the streaming media program according to the identifier of the streaming media program, the position information, and user flags that are received by the information receiving unit.

It can be seen that, in this embodiment, when playing a streaming media program, a client may receive a user flag to mark given streaming media data in the streaming media program, for example, first streaming media data, and send position information of the first streaming media data marked by the user flag, the user flag, and an identifier of the streaming media program to a server, so that the server counts the quantity of user flags on streaming media data at each position of the streaming media program. Each client sends, to the server, user flags on different positions of a streaming media program, and the server counts the quantities of user flags, and in this way, degrees of interest of users in streaming media data at different positions of a streaming media program can be learned, thereby facilitating the user in searching for a desired part.

### BRIEF DESCRIPTION OF THE DRAWINGS

To illustrate the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of a method for collecting statistics on streaming media data according to an embodiment of the present invention;

FIG. 2 is a flowchart of another method for collecting statistics on streaming media data according to an embodiment of the present invention;

FIG. 3 is a flowchart of another method for collecting statistics on streaming media data according to an embodiment of the present invention;

FIG. 4 is a flowchart of another method for collecting statistics on streaming media data according to an embodiment of the present invention;

FIG. 5 is a distribution diagram of information about the quantity of user flags counted by a server according to an embodiment of the present invention;

FIG. 6 is a schematic structural diagram of a client according to an embodiment of the present invention;

FIG. 7 is a schematic structural diagram of another client according to an embodiment of the present invention;

FIG. 8 is a schematic structural diagram of a server according to an embodiment of the present invention; and

FIG. 9 is a schematic structural diagram of another server according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

The terms such as “first”, “second”, “third”, and “fourth” (if any) used in the specification, the claims, and the foregoing accompanying drawings of the present disclosure are used to distinguish similar objects, and are not necessarily used to describe a specific sequence or specific precedence order. It should be understood that, data used in this manner may be interchanged in a proper circumstance, so that the embodiments of the present invention described herein can be implemented in other sequences than the sequence shown in the drawings or described herein. Moreover, the terms “include”, “have”, and any variants thereof are intended to cover a non-exclusive inclusion, for example, a process, a method, a system, a product, or a device including a series of steps or units is not necessarily limited to the steps or units specified expressly, but may include other steps or units not specified expressly or inherent to the process, method, product or device.

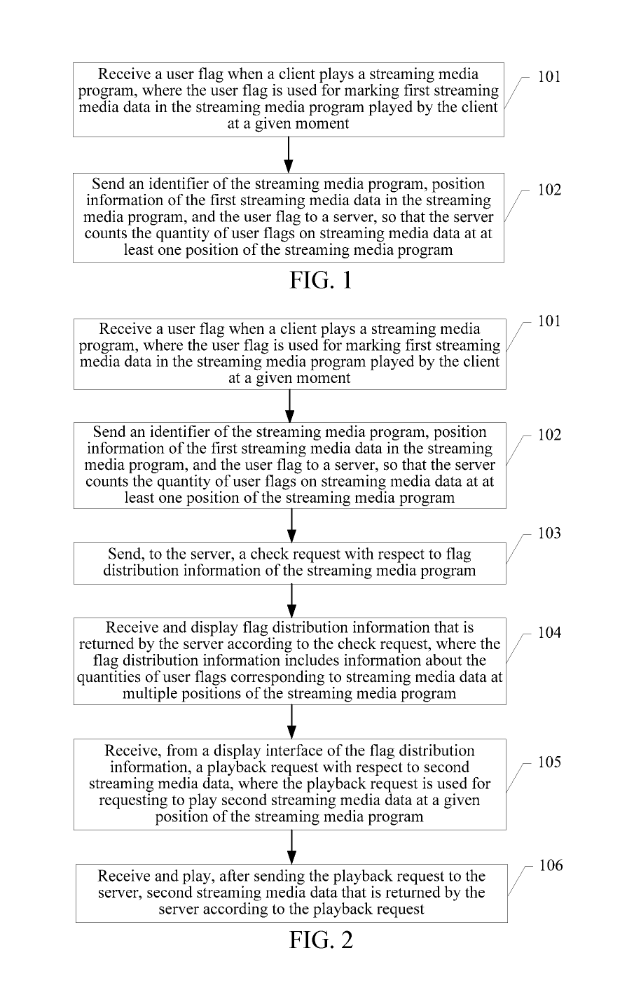

An embodiment of the present invention provides a method for collecting statistics on streaming media data, mainly a method executed by a client that supports playback of a streaming media program. A flowchart of the method is shown in FIG. 1, and the method includes:

Step 101: Receive a user flag when a client plays a streaming media program, where the user flag is used for marking first streaming media data in the streaming media program played by the client at a given moment.

In this embodiment, a client provides a user interface, so that when the client plays a streaming media program, a user can mark, through the user interface, streaming media data of the streaming media program played by the client at any moment, for example, the user marks streaming media data by clicking an icon provided on an interface of the client for playing the streaming media program, and in this way, the client receives a user flag from the user interface.

Step 102: Send an identifier of the streaming media program, position information of the first streaming media data in the streaming media program, and the user flag to a server, so that the server stores the identifier of the streaming media program, the position information, and the user flag correspondingly, and counts the quantity of user flags, sent by multiple clients, on streaming media data at at least one position of a given streaming media program according to the identifier of the streaming media program, the position information, and user flags that are stored.

An identifier of a streaming media program is unique information for identifying the streaming media program, and a name or address information of the streaming media program may be used for identification; and the position information of the first streaming media data in the streaming media program may be represented by a playback moment of the first streaming media data.

It can be seen that, in this embodiment, when playing a streaming media program, a client may receive a user flag to mark given streaming media data in the streaming media program, for example, first streaming media data, and send position information of the first streaming media data marked by the user flag, the user flag, and an identifier of the streaming media program to a server, so that the server counts the quantity of user flags on streaming media data at each position of the streaming media program. Each client sends, to the server, user flags on different positions of a streaming media program, and the server counts the quantities of user flags, and in this way, degrees of interest of users in streaming media data at different positions of a streaming media program can be learned, thereby facilitating the user in searching for a desired part.

It should be noted that, in steps 101 to 102 in the foregoing embodiment, the client sends, to the server, information marked by the received user flag, so that the server collects statistics; further, before any user plays the streaming media program by operating a client, the user may first check statistical information collected by the server, and then determines, according to the statistical information collected by the server and displayed on the client intuitively, a start position for playing the streaming media program. In this process, in addition to steps 101 to 102 described above, the client further needs to execute the following steps 103 to 106, and a flowchart is shown in FIG. 2. Specifically:

Step 103: Send, to the server, a check request with respect to flag distribution information of the streaming media program.

It can be understood that, the user may operate the user interface that is provided by the client for the user, to initiate a process of checking the flag distribution information, and the client sends a check request to the server, where the check request carries information such as the identifier of the streaming media program.

Step 104: Receive and display flag distribution information that is returned by the server according to the check request, where the flag distribution information includes information about the quantities of user flags corresponding to streaming media data at multiple positions of the streaming media program.

After the client displays the flag distribution information returned by the server, the user may click, on a display interface of the flag distribution information, information at a given position of the streaming media program. For example, if it is displayed on the display interface of the flag distribution information that a position of the streaming media program corresponds to a relatively large quantity of user flags, it indicates that users are interested in streaming media data at this position, and the streaming media data at this position may be important or attractive; the user may click information at this position, and in this case, the client receives a playback request with respect to given streaming media data (for example, second streaming media data).

Step 105: Receive, from a display interface of the flag distribution information, a playback request with respect to second streaming media data, where the playback request is used for requesting to play second streaming media data at a given position of the streaming media program, and the playback request may carry position information of the second streaming media data in the streaming media program, and the like.

Step 106: The server sends, after the playback request is sent to the server, data of the streaming media program to the client according to a time sequence starting from the second streaming media data, and the client receives and plays the second streaming media data that is returned by the server according to the playback request.

Though steps 103 to 106 described above, the user can choose to watch the streaming media program from a given position of the streaming media program according to the flag distribution information collected by the server.

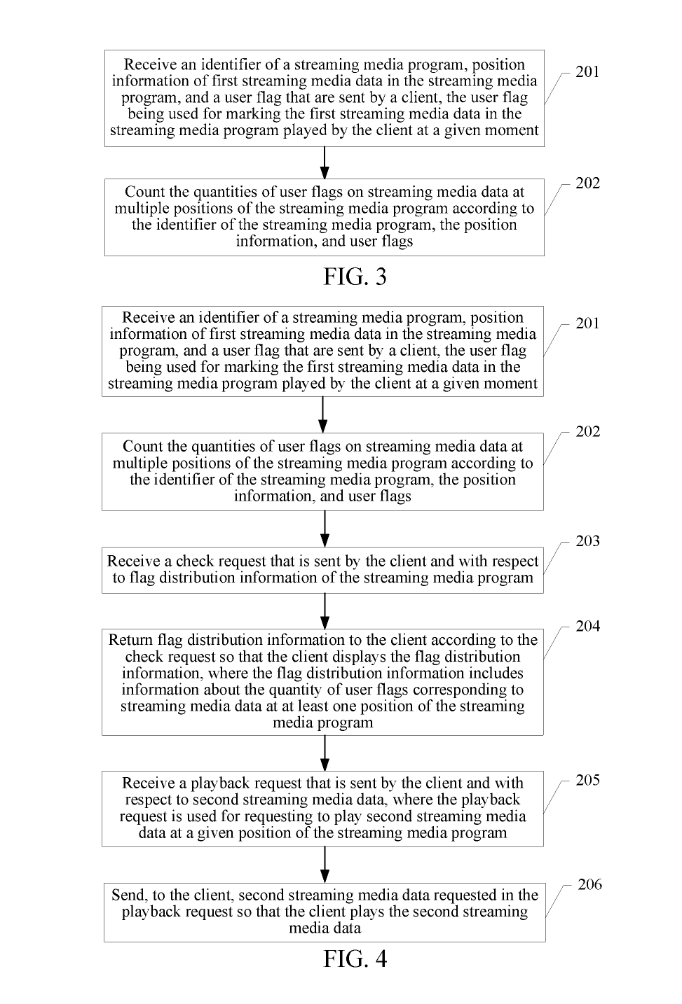

An embodiment of the present invention further provides another method for collecting statistics about streaming media data, where the method is executed by a server that provides streaming media programs. A flowchart is shown in FIG. 3, and the method includes:

Step 201: Receive an identifier of a streaming media program, position information of first streaming media data in the streaming media program, and a user flag that are sent by a client, the user flag being used for marking the first streaming media data in the streaming media program played by the client at a given moment.

It can be understood that, the client may send information such as a user flag to the server according to steps 101 to 102 described above, which is not described in detail herein again.

Step 202: Count the quantities of user flags on streaming media data at multiple positions of the streaming media program according to the identifier of the streaming media program, the position information, and user flags, where the position information herein may be represented by time points.

The server may comprehensively count the quantities of user flags that are sent by multiple clients for multiple time points corresponding to an identifier of a same streaming media program. For example, at a time point of a streaming media program, if information sent by n clients contains a user flag for this time point, the quantity of user flags at this time point is n; then, the server calculates a functional correspondence between the quantities of user flags and time points according to a statistical result, namely, a functional correspondence expressing the change of quantity of user flags as the time point changes.

It can be seen that, in this embodiment, the server receives an identifier of a streaming media program, position information of first streaming media data marked by a user flag, and user flags that are sent by clients, and counts the quantities of user flags on streaming media data at different positions of the streaming media program. Each client sends, to the server, user flags on different positions of a streaming media program, and the server counts the quantities of user flags, and in this way, degrees of interest of users in streaming media data at different positions of a streaming media program can be learned, thereby facilitating the user in searching for a desired part.

It should be noted that, in steps 201 to 202 in the foregoing embodiment, the server collects statistics on information marked by user flags sent by the clients, and further, any user may operate a client to check flag distribution information collected by the server, and request to play the streaming media program from a given position according to the flag distribution information. In this process, in addition to steps 201 to 202 described above, the server further needs to execute the following steps 203 to 206, and a flowchart is shown in FIG. 4. Specifically:

Step 203: Receive a check request that is sent by the client and with respect to flag distribution information of the streaming media program, where the check request includes the identifier of the streaming media program, so that the server can find corresponding flag distribution information according to the identifier of the streaming media program.

Step 204: Return flag distribution information to the client according to the check request so that the client displays the flag distribution information, where the flag distribution information includes information about the quantity of user flags corresponding to streaming media data at at least one position of the streaming media program.

Step 205: Receive a playback request that is sent by the client and with respect to second streaming media data, where the playback request is used for requesting to play second streaming media data at a given position of the streaming media program, and the playback request includes position information of the second streaming media data in the streaming media program, and the like.

Step 206: Send, to the client, second streaming media data requested in the playback request so that the client plays the second streaming media data.

The method for collecting statistics on streaming media data provided by the present disclosure is described in the following by using a specific embodiment, and in this embodiment, the streaming media program is a video program.

First Stage: Add User Flags to a Video Program.

When a client plays a video program, a user may click, at any point of the video program played by the client, a video “like” button provided by the client, to mark video data at this time point; and the client sends <video program ID, user flag, video time point> as a record to the server.

Second Stage: The Server Collects Statistics.

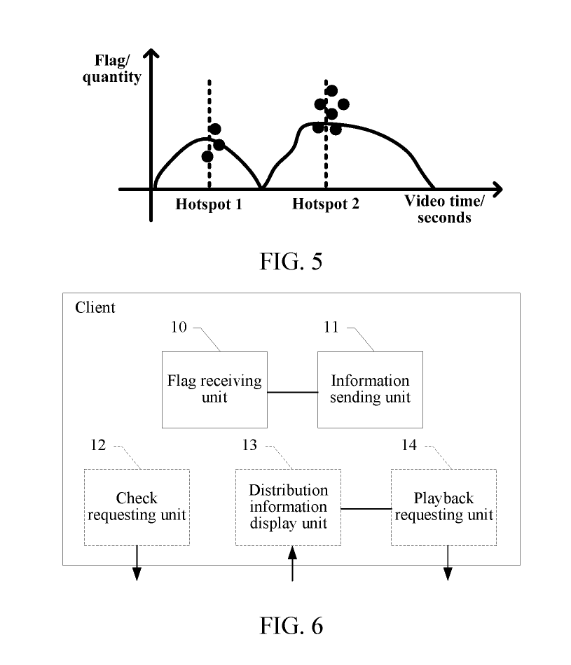

The server may receive multiple records sent by multiple clients; the server collects statistics on related records that are sent by multiple clients and based on a same video program ID, counts the quantities of user flags at different video time points in the video program, and then obtains a functional relationship between video time points and the quantities of user flags. For example, FIG. 5 shows the quantities of user flags at different video time points counted by the server, and it can be seen that video time points of hotspot 1 and hotspot 2 correspond to large quantities of user flags, which indicates that relatively large quantities of users are interested in these two video time points of the video program.

Third Stage: Check and Play.

Before a user requests, by using a client, the server to play the video program, the user may first send a request to the server, requesting to check flag distribution information of the video program, and the server may send the distribution diagram shown in FIG. 5 to the client; then, the user may click any video time point, to request the server to send video data at this video time point.

An embodiment of the present invention further provides a client; a schematic structural diagram of the client is shown in FIG. 6, and the client includes:

a flag receiving unit 10, configured to receive a user flag when a client plays a streaming media program, the user flag being used for marking first streaming media data in the streaming media program played by the client at a given moment; and

an information sending unit 11, configured to send an identifier of the streaming media program, position information of the first streaming media data in the streaming media program, and the user flag that is received by the flag receiving unit 10 to a server, so that the server counts the quantity of user flags on streaming media data at at least one position of the streaming media program according to the identifier of the streaming media program, the position information, and user flags.

Each client sends, to the server, user flags on different positions of a streaming media program, and the server counts the quantities of user flags, and in this way, degrees of interest of users in streaming media data at different positions of a streaming media program can be learned, thereby facilitating the user in searching for a desired part.

Further, as shown in FIG. 6, in a specific embodiment, the client may further include a check requesting unit 12, a distribution information display unit 13, and a playback requesting unit 14 (the dashed box in FIG. 6 is used to indicate a unit that can be further added), where

the check requesting unit 12 is configured to send, to the server, a check request with respect to flag distribution information of the streaming media program;

the distribution information display unit 13 is configured to receive and display flag distribution information that is returned by the server according to the check request sent by the check requesting unit 12, the flag distribution information including information about the quantities of user flags corresponding to streaming media data at multiple positions of the streaming media program; and

the playback requesting unit 14 is configured to receive, from a display interface of the flag distribution information displayed by the distribution information display unit 13, a playback request with respect to second streaming media data, the playback request being used for requesting to play second streaming media data at a given position of the streaming media program; and receive and play, after sending the playback request to the server, second streaming media data that is returned by the server according to the playback request.

An example in which the method for collecting statistics on streaming media data according to an embodiment of the present invention is applied to a terminal is used for description in the following. The terminal may include a smart phone, a tablet computer, an ebook reader, a Moving Picture Experts Group Audio Layer III (MP3) player, a Moving Picture Experts Group Audio Layer IV (MP4) player, a laptop portable computer, a desktop computer, or the like.

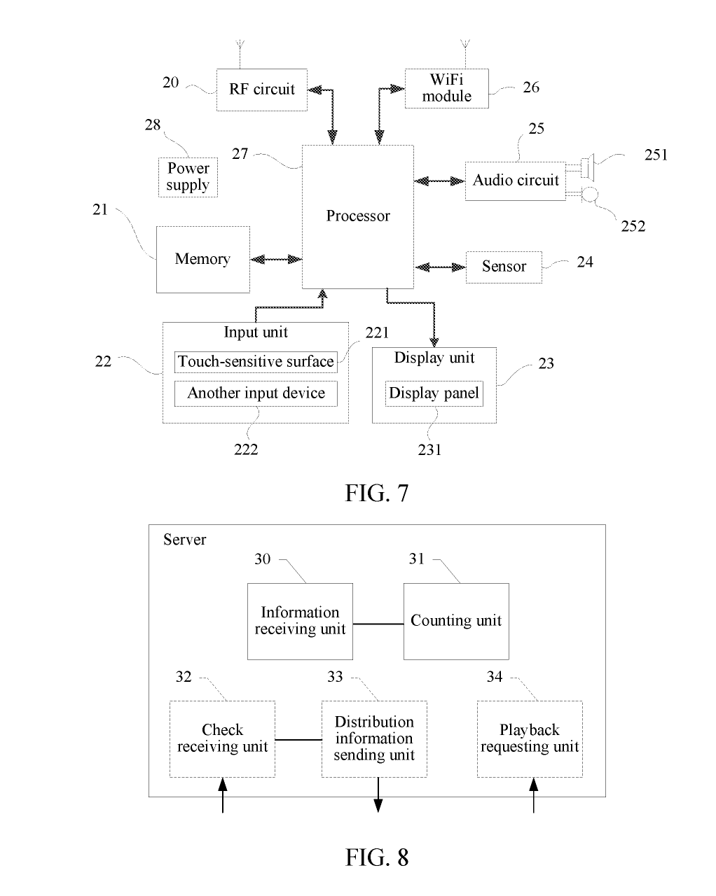

Referring to FIG. 7, FIG. 7 shows a schematic structural diagram of a terminal involved in the embodiments of the present invention.

Specifically, the terminal may include components such as a radio frequency (RF) circuit 20, a memory 21 including one or more computer readable storage media, an input unit 22, a display unit 23, a sensor 24, an audio circuit 25, a Wireless Fidelity (WiFi) module 26, a processor 27 including one or more processing cores, and a power supply 28. A person skilled in the art may understand that, the structure of the terminal shown in FIG. 7 does not constitute a limitation to the terminal, and the terminal may include more components or fewer components than those shown in the figure, or some components may be combined, or a different component deployment may be used.

The RF circuit 20 may be configured to receive and send signals during an information sending and receiving process or a call process. Particularly, the RF circuit 20 receives downlink information from a base station, then delivers the downlink information to the one or more processors 27 for processing, and sends related uplink data to the base station. Generally, the RF circuit 20 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 20 may also communicate with a network and another device by wireless communication. The wireless communication may use any communications standard or protocol, which includes, but is not limited to, Global System of Mobile Communication (GSM), General Packet Radio Service (GPRS), Code Division Multiple Access (CDMA), Wideband Code Division Multiple Access (WCDMA), Long Term Evolution, (LTE), e-mail, Short Messaging Service (SMS), and the like.

The memory 21 may be configured to store a software program and module. The processor 27 runs the software program and module stored in the memory 21, to implement various functional applications and data processing. The memory 21 may mainly include a program storage area and a data storage area. The program storage area may store an operating system, an application program required by at least one function (such as a sound playback function and an image display function), and the like. The data storage area may store data (such as audio data and an address book) created according to use of the terminal, and the like. In addition, the memory 21 may include a high-speed random access memory, and may also include a non-volatile memory, such as at least one magnetic disk storage device, a flash memory, or another volatile solid-state storage device. Accordingly, the memory 21 may further include a memory controller, so that the processor 27 and the input unit 22 access the memory 21.

The input unit 22 may be configured to receive input digit or character information, and generate a keyboard, mouse, joystick, optical, or track ball signal input related to the user setting and function control. Specifically, in a specific embodiment, the input unit 22 may include a touch-sensitive surface 221 and another input device 222. The touch-sensitive surface 221, which may also be referred to as a touch screen or a touch panel, may collect a touch operation of a user on or near the touch-sensitive surface (such as an operation of a user on or near the touch-sensitive surface 221 by using any suitable object or accessory, such as a finger or a stylus), and drive a corresponding connection apparatus according to a preset program. Optionally, the touch-sensitive surface 221 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 27. Moreover, the touch controller can receive and execute a command sent from the processor 27. In addition, the touch-sensitive surface 221 may be a resistive, capacitive, infrared, or surface acoustic wave type touch-sensitive surface. In addition to the touch-sensitive surface 221, the input unit 22 may further include the another input device 222. Specifically, the another input device 222 may include, but is not limited to, one or more of a physical keyboard, a functional key (such as a volume control key or a switch key), a track ball, a mouse, and a joystick.

The display unit 23 may be configured to display information input by the user or information provided for the user, and various graphical user interfaces of the terminal. The graphical user interfaces may be formed by a graph, a text, an icon, a video, and any combination thereof. The display unit 23 may include a display panel 231. Optionally, the display panel 231 may be configured by using a liquid crystal display (LCD), an organic light-emitting diode (OLED), or the like. Further, the touch-sensitive surface 221 may cover the display panel 231. After detecting a touch operation on or near the touch-sensitive surface 221, the touch-sensitive surface 131 transfers the touch operation to the processor 27, so as to determine the type of the touch event. Then, the processor 27 provides a corresponding visual output on the display panel 231 according to the type of the touch event. Although, in FIG. 7, the touch-sensitive surface 221 and the display panel 231 are used as two separate parts to implement input and output functions, in some embodiments, the touch-sensitive surface 221 and the display panel 231 may be integrated to implement the input and output functions.

The terminal may further include at least one sensor 24, such as an optical sensor, a motion sensor, and other sensors. Specifically, the optical sensor may include an ambient light sensor and a proximity sensor. The ambient light sensor may adjust luminance of the display panel 231 according to brightness of the ambient light. The proximity sensor may switch off the display panel 231 and/or backlight when the terminal is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the terminal (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal, are not further described herein.

The audio circuit 25, a loudspeaker 251, and a microphone 252 may provide audio interfaces between the user and the terminal. The audio circuit 25 may convert received audio data into an electric signal and transmit the electric signal to the loudspeaker 251. The loudspeaker 251 converts the electric signal into a sound signal for output. On the other hand, the microphone 252 converts a collected sound signal into an electric signal. The audio circuit 25 receives the electric signal and converts the electric signal into audio data, and outputs the audio data to the processor 27 for processing. Then, the processor 180 sends the audio data to, for example, another terminal device by using the RF circuit 20, or outputs the audio data to the memory 21 for further processing. The audio circuit 25 may further include an earplug jack, so as to provide communication between a peripheral earphone and the terminal.

WiFi is a short distance wireless transmission technology. The terminal may help, by using a WiFi module 26, the user to receive and send e-mails, browse web pages, access stream media, and so on, which provides wireless broadband Internet access for the user. Although FIG. 7 shows the WiFi module 26, it may be understood that the WiFi module is not a necessary component of the terminal, and when required, the WiFi module may be omitted as long as the scope of the essence of the present disclosure is not changed.

The processor 27 is the control center of the terminal, and is connected to various parts of the terminal by using various interfaces and lines. By running or executing the software program and/or module stored in the memory 21, and invoking data stored in the memory 21, the processor 180 performs various functions and data processing of the terminal, thereby performing overall monitoring on the terminal. Optionally, the processor 27 may include one or more processing cores. Preferably, the processor 27 may integrate an application processor and a modem processor. The application processor mainly processes an operating system, a user interface, an application programs, and the like, and the modem processor mainly processes wireless communication. It can be understood that the foregoing modem processor may not be integrated in the processor 27.

The terminal further includes the power supply 28 (such as a battery) that supplies power to each component. Preferably, the power supply may be logically connected to the processor 27 through a power management system, so that functions such as charging, discharging, power consumption management are managed by using the power management system. The power supply 28 may further include any component, such as one or more direct current or alternating current power supplies, a re-charging system, a power supply fault detection circuit, a power supply converter or an inverter, and a power supply state indicator.

Although not shown in the figure, the terminal may further include a camera, a Bluetooth module, and the like, which are not further described herein. Specifically, in this embodiment, processor 27 in the terminal will execute, according to the following instructions, an executable file corresponding to a process of one or more application programs stored in the memory 21, thereby implementing various functions:

When playing a streaming media program, a client receives a user flag, the user flag being used for marking first streaming media data in the streaming media program played by the client at a given moment; an identifier of the streaming media program, position information of the first streaming media data in the streaming media program, and the received user flag are sent to a server, so that the server counts the quantity of user flags on streaming media data at at least one position of the streaming media program according to the identifier of the streaming media program, the position information, and user flags. Each client sends, to the server, user flags on different positions of a streaming media program, and the server counts the quantities of user flags, and in this way, degrees of interest of users in streaming media data at different positions of a streaming media program can be learned, thereby facilitating the user in searching for a desired part.

Further, the processor 27 is further configured to send, to the server, a check request with respect to flag distribution information in the streaming media program; receive and display flag distribution information that is returned by the server according to the check request, the flag distribution information including information about the quantities of user flags corresponding to streaming media data at multiple positions in the streaming media program; receive, from a display interface of the flag distribution information, a playback request with respect to second streaming media data, the playback request being used for requesting to play second streaming media data at a given position of the streaming media program; and receive and play, after sending the playback request to the server, second streaming media data that is returned by the server according to the playback request.

An embodiment of the present invention further provides a server; a schematic structural diagram of the server is shown in FIG. 8, and the server includes:

an information receiving unit 30, configured to receive an identifier of a streaming media program, position information of first streaming media data in the streaming media program, and a user flag that are sent by a client, the user flag being used for marking the first streaming media data in the streaming media program played by the client at a given moment; and

a counting unit 31, configured to count the quantities of user flags on streaming media data at multiple positions in the streaming media program according to the identifier of the streaming media program, the position information, and user flags that are received by the information receiving unit 30.

If the position information is a time point, the counting unit 31 is specifically configured count the quantities of user flags that are sent by multiple clients and for multiple time points corresponding to an identifier of a same streaming media program; and calculate a functional correspondence between the counted quantities of user flags and the time points.

Each client sends, to the server, user flags on different positions of a streaming media program, and the server counts the quantities of user flags, and in this way, degrees of interest of users in streaming media data at different positions of a streaming media program can be learned, thereby facilitating the user in searching for a desired part.

Further, as shown in FIG. 8, in a specific embodiment, the server may further include a check receiving unit 32, a distribution information sending unit 33, and a playback sending unit 34 (the dashed box in FIG. 8 is used to indicate a unit that can be further added), where

the check receiving unit 32 is configured to receive a check request sent by the client and with respect to flag distribution information of the streaming media program; and

a distribution information sending unit 33 is configured to return, according to the check request received by the check receiving unit 32, flag distribution information to the client for display, the flag distribution information including information about the quantity of user flags corresponding to streaming media data at at least one position of the streaming media program; and

the playback sending unit 34 is configured to receive a playback request that is sent by the client and with respect to second streaming media data, the playback request being used for requesting to play second streaming media data at a given position of the streaming media program; and send the second streaming media data requested in the playback request to the client for playback.

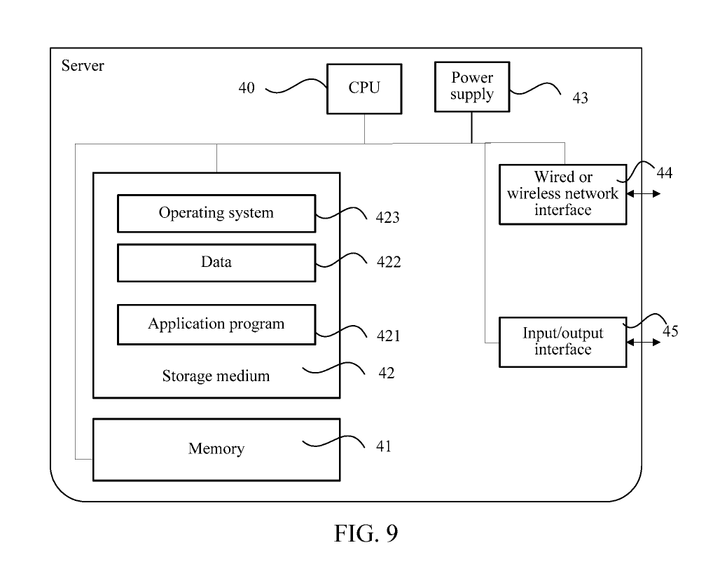

The present disclosure further provides a server, and a schematic structural diagram of the server is shown in FIG. 9. The server may differ a lot due to different configurations or performance, and may include one or more central processing units (CPUs) 40 (for example, one or more processors), a memory 41, one or more storage media 42 (for example, one or more massive storage devices) for storing an application program 421 or data 422. The memory 41 and the storage medium 42 may be temporary storage or permanent storage. The program stored in the storage medium 42 may include one or more modules (not shown in the figure), and each module may include a series of instruction operations on the server. Further, the CPU 40 may be configured to communicate with the storage medium 42, and execute, on the server, a series of instruction operations in the storage medium 42.

The server may further include one or more power supplies 43, one or more wired or wireless network interfaces 44, one or more input/output interfaces 45, and/or, one or more operating systems 423, for example, Windows Server™, Mac OS X™, Unix™, Linux™, and FreeBSD™. In the foregoing methods, steps of the method for collecting statistics about streaming media data executed by the server may be based on the server structure shown in FIG. 9.

An embodiment of the present invention further provides a system for collecting statistics on streaming media data, including a server and multiple clients, where the client is any client according to the foregoing embodiments, and the server is any server according to the foregoing embodiments.

A persons of ordinary skill in the art should understand that all or a part of the steps of the methods according to the foregoing embodiments may be implemented by a program instructing relevant hardware. The program may be stored in a computer readable storage medium, and the storage medium may include a read-only memory (ROM), a random access memory (RAM), a magnetic disk, or an optical disc.

A method and system for collecting statistics on streaming media data, and a related apparatus according to the embodiments of the present invention are described above in detail. Specific examples are used to illustrate principles and implementation manners of the present disclosure. The above descriptions of the embodiments are merely used to help understand the method of the present disclosure and the core idea thereof. Meanwhile, a person of ordinary skill in the art may make modifications to the specific implementation manners and application ranges according to the idea of the present disclosure. In conclusion, the content of the specification shall not be regarded as a limitation to the present disclosure.

What is claimed is:

1. A method for collecting statistics on streaming media data, comprising:
receiving a user flag when a client plays a streaming media program, the user flag being used for marking first streaming media data in the streaming media program played by the client at a given moment; and
sending an identifier of the streaming media program, position information of the first streaming media data in the streaming media program, and the user flag to a server, so that the server counts the quantity of user flags on streaming media data at at least one position of the streaming media program according to the identifier of the streaming media program, the position information, and user flags.

2. The method according to claim 1, further comprising:
sending, to the server, a check request with respect to flag distribution information of the streaming media program; and
receiving and displaying flag distribution information that is returned by the server according to the check request, the flag distribution information comprising information about the quantities of user flags corresponding to streaming media data at multiple positions of the streaming media program.

3. The method according to claim 2, further comprising:
receiving, from a display interface of the flag distribution information, a playback request with respect to second streaming media data, the playback request being used for requesting to play second streaming media data at a given position of the streaming media program; and
receiving and playing, after sending the playback request to the server, second streaming media data that is returned by the server according to the playback request.

4. A method for collecting statistics on streaming media data, comprising:
receiving an identifier of a streaming media program, position information of first streaming media data in the streaming media program, and a user flag that are sent by a client, the user flag being used for marking the first streaming media data in the streaming media program played by the client at a given moment; and
counting the quantities of user flags on streaming media data at multiple positions in the streaming media program according to the identifier of the streaming media program, the position information, and user flags.

5. The method according to claim 4, wherein the position information is a time point, and the counting the quantities of user flags on streaming media data at multiple positions in the streaming media program according to the identifier of the streaming media program, the position information, and user flags specifically comprises:
counting the quantities of user flags that are sent by multiple clients and at multiple time points corresponding to an identifier of a same streaming media program; and
calculating a functional correspondence between the counted quantities of user flags and the time points.

6. The method according to claim 4, further comprising:
receiving a check request sent by the client and with respect to flag distribution information of the streaming media program; and
returning flag distribution information to the client according to the check request so that the client displays the flag distribution information, the flag distribution information comprising information about the quantity of user flags corresponding to streaming media data at at least one position of the streaming media program.

7. The method according to claim 5, further comprising:
receiving a check request sent by the client and with respect to flag distribution information of the streaming media program; and
returning flag distribution information to the client according to the check request so that the client displays the flag distribution information, the flag distribution information comprising information about the quantity of user flags corresponding to streaming media data at at least one position of the streaming media program.

8. The method according to claim 4, further comprising:
receiving a playback request that is sent by the client and with respect to second streaming media data, the playback request being used for requesting to play second streaming media data at a given position of the streaming media program; and
sending, to the client, second streaming media data requested in the playback request, so that the client plays the second streaming media data.

9. The method according to claim 5, further comprising:
receiving a playback request that is sent by the client and with respect to second streaming media data, the playback request being used for requesting to play second streaming media data at a given position of the streaming media program; and
sending, to the client, second streaming media data requested in the playback request, so that the client plays the second streaming media data.

10. A server, comprising:
one or more processors;
a memory; and
a plurality of program modules, when, executed by the one or more processors, cause the server to perform predefined functions, the plurality of program modules further comprising:
an information receiving module, configured to receive an identifier of a streaming media program, position information of first streaming media data in the streaming media program, and a user flag that are sent by a client, the user flag being used for marking the first streaming media data in the streaming media program played by the client at a given moment; and
a counting module, configured to count the quantities of user flags on streaming media data at multiple positions in the streaming media program according to the identifier of the streaming media program, the position information, and user flags that are received by the information receiving module.

11. The server according to claim 10, wherein the position information is a time point, and the counting module is specifically configured count the quantities of user flags that are sent by multiple clients and at multiple time points corresponding to an identifier of a same streaming media program; and calculate a functional correspondence between the counted quantities of user flags and the time points.

12. The server according to claim 10, the plurality of program modules further comprising:
a check receiving module, configured to receive a check request sent by the client and with respect to flag distribution information of the streaming media program; and
a distribution information sending module, configured to return, according to the check request received by the check receiving module, flag distribution information to the client for display, the flag distribution information comprising information about the quantity of user flags corresponding to streaming media data at at least one position of the streaming media program.

13. The server according to claim 11, the plurality of program modules further comprising:
a check receiving module, configured to receive a check request sent by the client and with respect to flag distribution information of the streaming media program; and
a distribution information sending module, configured to return, according to the check request received by the check receiving module, flag distribution information to the client for display, the flag distribution information comprising information about the quantity of user flags corresponding to streaming media data at at least one position of the streaming media program.

14. The server according to claim 10, the plurality of program modules further comprising:
a playback sending module, configured to receive a playback request that is sent by the client and with respect to second streaming media data, the playback request being used for requesting to play second streaming media data at a given position of the streaming media program; and send the second streaming media data requested in the playback request to the client for playback.

15. The server according to claim 11, the plurality of program modules further comprising:
a playback sending module, configured to receive a playback request that is sent by the client and with respect to second streaming media data, the playback request being used for requesting to play second streaming media data at a given position of the streaming media program; and send the second streaming media data requested in the playback request to the client for playback.
